(19) United States
(12) Patent Application Publication
(10) Pub. No.: US 2019/0210503 A1
(43) Pub. Date: Jul. 11, 2019

(54) Occupant-Assist Mobility Handle

(71) Applicants: Bobbie Morrison Donaldson, Port St. Lucie, FL (US); Heath Jarad Donaldson, Port St. Lucie, FL (US)

(72) Inventors: Bobbie Morrison Donaldson, Port St. Lucie, FL (US); Heath Jarad Donaldson, Port St. Lucie, FL (US)

(21) Appl. No.: 16/149,896

(22) Filed: Oct. 2, 2018

Related U.S. Application Data
(60) Provisional application No. 62/615,541, filed on Jan. 10, 2018.

(51) Int. Cl. B60N 3/02

(52) U.S. Cl. CPC B60N 3/026

(57) ABSTRACT

An occupant-assist mobility handle for helping occupants ingress and egress out of a three-wheeled motor vehicle includes a handle, a base plate, a first mounting slot, a second mounting slot, and an arm attachment mount. The handle can be grasped for support for entering and exiting the cockpit of the vehicle. The handle mounts onto an arm mount of the vehicle through the base plate. As such, the base plate is designed to withstand several hundred pounds of force generated by an occupant pulling or pushing on the handle. The first mounting slot and the second mounting slot traverse through the base plate and allow the base plate to be bolted onto the arm mount. Finally, the arm attachment mount is provided for reattaching the mirror arm in the original position, in clear view of the occupant.

The current application claims a priority to the U.S. Provisional Patent application Ser. No. 62/615,541 filed on Jan. 10, 2018.

### FIELD OF THE INVENTION

The present invention generally relates to an occupant-assist mobility handle.

More specifically, the present invention is a mobility handle that can be inconspicuously attached to the exterior of an open-top three-wheeled motor vehicle.

### BACKGROUND OF THE INVENTION

The present invention is an occupant-assist mobility handle for helping occupants ingress and egress out of a Polaris Slingshot motor vehicle. The Polaris Slingshot is an open-top, three-wheeled motor vehicle, that lacks the usual supports for helping people getting in and out of the vehicle. As such, larger or heavy-set people must grab on to the dash or the steering wheel for support, which in occasion, has broken the driver column and, in many occasions, made people unable to exit the vehicle.

The present invention is a solution to make it easier to get in and out of the cockpit of the Slingshot. The present invention can be installed in less than ten minutes to either the driver side or the passenger side of the vehicle, thereby providing occupants with a handle to grab hold of and pull themselves in and out of the vehicle without getting injured.

The present invention is a retrofittable handle that retrofits onto an existing mirror arm mount on the Polaris Slingshot. The handle is installed by removing the original base plate and attaching a new base plate. The new base plate, designed specifically for the Polaris Slingshot, securely connects the handle to the arm mount. The handle is also provided with an arm attachment mount for reattaching the mirror arm.

The handle is designed to attach low and close to the chassis of the Slingshot, so as not to obscure the occupant's view. Further, the handle reclines towards the rear of the vehicle to reduce aerodynamic drag and prevent buffeting and the associated noise. The arm attachment mount is positioned facing upwards in relation to the vehicle. This allows the mirror arm to be mounted in clear view of the driver.

As such, the handle provides a robust support that helps occupants ingress and egress out of the vehicle without significantly affecting the driving dynamics or the safety of the vehicle.

### BRIEF DESCRIPTION OF THE DRAWINGS

FIG. 1 is a front right perspective view of the present invention.

FIG. 2 is a front left perspective view of the present invention.

FIG. 3 is a front right perspective view illustrating the connection between the distal portion and the base plate.

FIG. 4 is a top plan view illustrating the orientation between the first normal axis and the first longitudinal axis.

FIG. 5 is a right-side plan view illustrating the orientation between the first longitudinal axis and the second longitudinal axis.

FIG. 6 is a bottom left perspective view illustrating the base plate of the arm attachment mount.

FIG. 7 is a detail view of section 7 in FIG. 6, illustrating the connection between the threaded nut and the tab.

FIG. 8 rear perspective view illustrating the structural reinforcement plate and the base plate detached from the handle.

FIG. 9 is a top plan view thereof illustrating the orientation between the convex side and the concave side.

### DETAILED DESCRIPTION OF THE INVENTION

All illustrations of the drawings are for the purpose of describing selected versions of the present invention and are not intended to limit the scope of the present invention.

The present invention is an occupant-assist mobility handle for assisting occupants in getting in and out of a three-wheeled motor vehicle. The preferred embodiment of the present invention attaches to the frame of a Polaris Slingshot and is specifically designed for this particular model. In alternate embodiments, the present invention may be configured to attach to different models of three-wheeled motor vehicles.

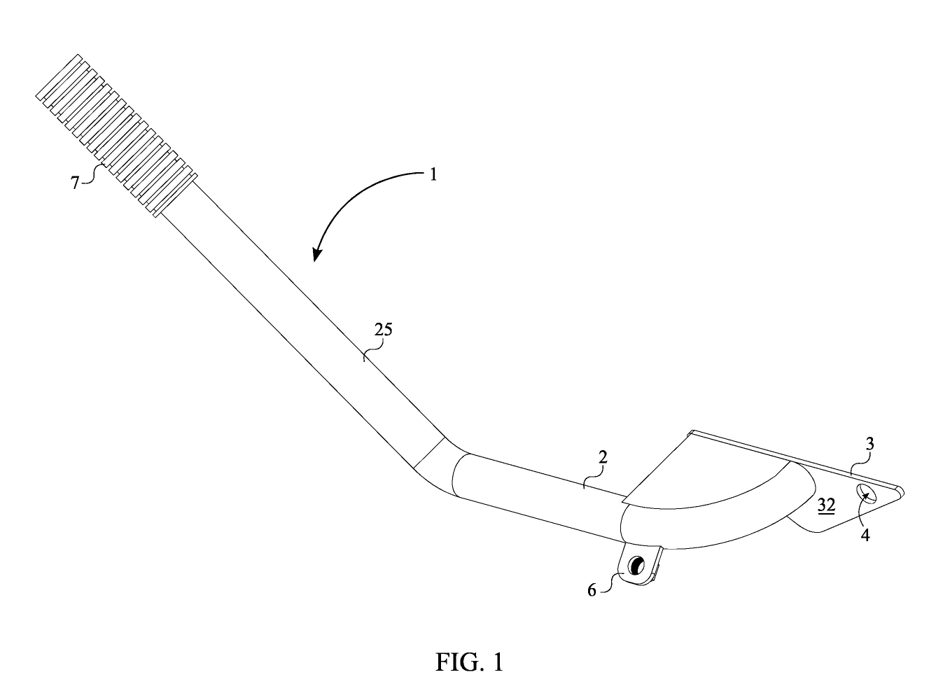

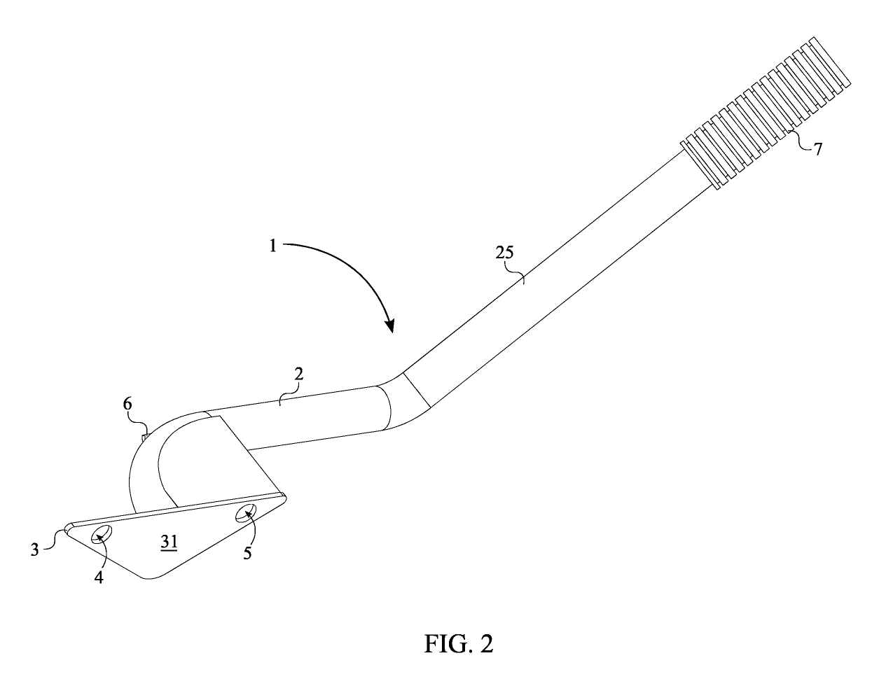

Referring to FIG. 1 and FIG. 2, the present invention comprises a handle 1, a base plate 3, a first mounting slot 4, a second mounting slot 5, and an arm attachment mount 6. The handle 1 is designed specifically to be grasped or held by hand and assists occupants in getting in and out of the vehicle. In the preferred implementation, the base plate 3 attaches the handle 1 to the frame of the vehicle. The preferred base plate 3 is a sheet of metal capable of supporting up to 300 pounds of force applied to the handle 1. Further, the preferred base plate 3 is identical to the base plate 3 of the Polaris Slingshot, used normally to attach the mirror arm to the arm mount. As such, the base plate 3 has a generally triangular shape. However, in alternate embodiments, depending on the specific model of the tri-wheeled vehicle, the shape of the base plate 3 may change.

In the preferred embodiment of the present invention, “occupant” may refer to either the driver or the passenger of the Slingshot. With respect to the preferred embodiment, the present invention may be described in relation to either the driver-side of the vehicle or passenger-side of the vehicle, and as such, is designed to connect onto the both occupant-side arm mount or the driver-side arm mount. As such, “arm mount”, “mirror arm”, and “cockpit”, as herein referred, may be located on either the driver-side of the vehicle or the passenger-side of the vehicle. To switch between the driver-side and the passenger-side, the present invention can be simply mirrored about the longitudinal axis of the vehicle while retaining the same components and connections.

Accordingly, to attach the present invention to the frame of the vehicle, a left-side mirror arm or a right-side mirror arm of the vehicle is removed from the corresponding arm mount and the base plate 3 is connected thereon. Preferably, the base plate 3 comprises a contact face 31 and the exterior face 32. As the names imply, the contact face 31 contacts the arm mount, whereas the exterior face 32 is configured facing outwards to receive the handle 1. Accordingly, the handle 1 comprises a distal portion 2 and a proximal portion 25. “Distal” and “Proximal” refers to the position of the handle 1 in relation to the occupant. Thus, the distal portion 2 of the handle 1 is positioned away from the occupant and close to the arm mount, whereas the proximal portion 25 of the handle 1 is positioned close to the occupant and away from the arm mount. As such, the proximal portion 25 is terminally connected to the exterior face 32 of the base plate 3. Similarly, the distal portion 2 is adjacently connected to the exterior face 32 of the base plate 3.

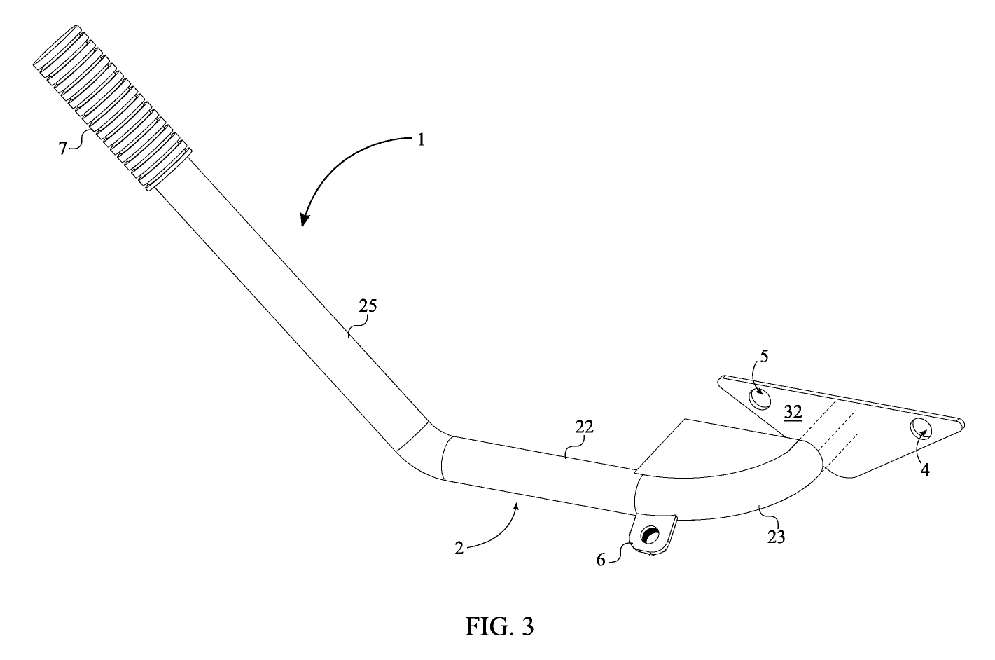

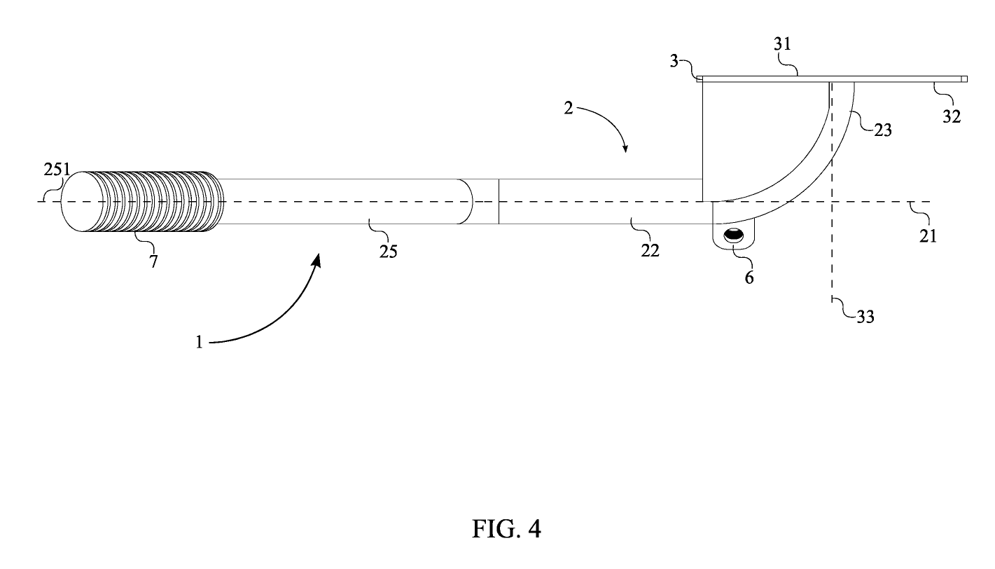

Referring to FIG. 3 and FIG. 4, in the preferred embodiment, the distal portion 2 is permanently affixed onto the base plate 3. For example, the distal portion 2 may be welded to the base plate 3. In contrast, the base plate 3 is retrofitted onto the arm mount of the vehicle via the first mounting slot 4 and the second mounting slot 5. As such, the first mounting slot 4 traverses through the base plate 3 from the exterior face 32 to the contact face 31. Similarly, the second mounting slot 5 also traverses through the base plate 3 from the exterior face 32 to the contact face 31. The first mounting slot 4 and the second mounting slot 5 each allow a bolt to traverse through the base plate 3 into the arm mount. The bolt preferably screws into a threaded hole of the arm mount, thereby preventing the separation of the base plate 3 from the arm mount. To properly align the base plate with the arm mount, the first mounting slot 4 and the second mounting slot 5 are positioned opposite each other about the distal portion 2. This concentrically aligns the first mounting slot 4 and the second mounting slot 5 with the corresponding threaded hole of the arm mount. In alternate embodiments, depending on the type of fastener utilized on the arm mount, the first mounting slot 4 and the second mounting slot 5 may be designed for different fasteners.

Once the handle 1 is attached to the arm mount, the mirror arm is reattached to the handle 1 via the arm attachment mount 6. In the preferred embodiment, the mirror arm connects to the arm attachment mount 6 via a bolt. The bolt may be unfasted to disconnect the mirror arm from the arm attachment mount 6. Accordingly, the arm attachment mount 6 is connected adjacent to the distal portion 2. Further, the arm attachment mount 6 is positioned offset from the base plate 3. This positions the mirror arm in the occupant's line of sight and prevents the handle 1 from obscuring the occupant's vision.

The exterior face 32 and the contact face 31, as herein referred to, are opposite sides of the base plate 3. Given the substantially planar design of the base plate 3, the sides are best described as “faces”. As such, the exterior face 32 is positioned onto the base plate 3. Moreover, the contact face 31 is positioned onto the base plate 3, opposite the exterior face 32.

Referring to FIG. 4, the Polaris Slingshot has an open top cockpit that gives the occupant excellent all-around visibility. Preferably, the handle 1 is positioned low and close to the chassis to preserve this all-around visibility. As such, a first normal axis 33 is oriented perpendicular to the exterior face 32 of the base plate 3. The first normal axis 33 points out of the base plate 3 and determines the gap between the base plate 3 and the distal portion 2. Similarly, a first longitudinal axis 21 of the distal portion 2 is perpendicular to the first normal axis 33 of the base plate 3. The first longitudinal axis 21 traverses through the length of the distal portion 2 and determines the alignment of the distal portion 2 in relation to the base plate 3. Consequently, the distal portion 2 extends horizontally along the length of the chassis thereby remaining below the occupant's line of sight.

In contrast, the proximal portion 25 is configured to give the occupant a secure grip 7 to get in and out of the cockpit. As such, a second longitudinal axis 251 of the proximal portion 25 is oriented coplanar to the first longitudinal axis 21 of the distal portion 2. “Coplanar”, as herein referred to, is defined as being on the same plane. Thus, the second longitudinal axis 251 and the first longitudinal axis 21 are positioned on the same plane. By making the second longitudinal axis 251 coplanar to the first longitudinal axis 21, the proximal portion 25 is oriented parallel to the exterior face 32.

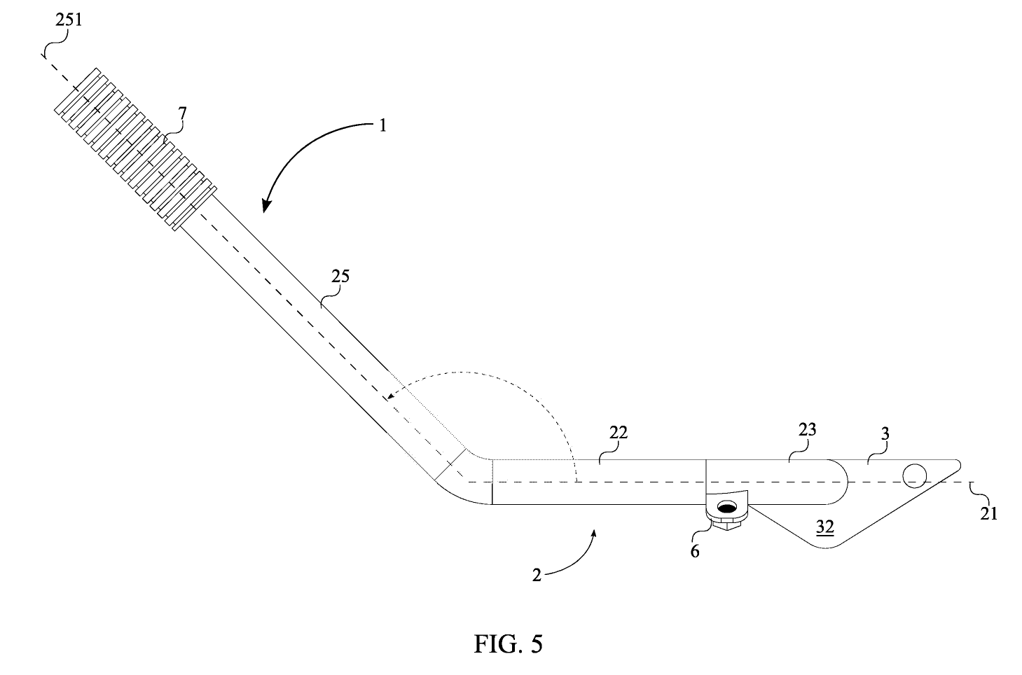

Referring to FIG. 5, further, the second longitudinal axis 251 of the proximal portion 25 is oriented at an angle to the first longitudinal axis 21 of the distal portion 2. Preferably, the first longitudinal axis 21 is oriented at a 45° angle counterclockwise, or a 135° angle clockwise, to the second longitudinal axis 251. Angling the second longitudinal axis 251 in relation to the first longitudinal axis 21, extends the proximal portion 25 into the cockpit. This positions the proximal portion 25 adjacent to the steering wheel, in easy reach of the occupant. Like the first longitudinal axis 21, the second longitudinal axis 251 traverses through the length of the proximal portion 25.

Referring back to FIG. 4, in the preferred embodiment of the present invention, the distal portion 2 comprises a straight tube 22 and an arcuate tube 23. The straight tube 22 distances the proximal portion 25 away from the arm mount and towards the occupant. Subsequently, the proximal portion 25 is terminally connected to the straight tube 22. Further, the arcuate tube 23 is terminally connected to the straight tube 22, opposite the proximal portion 25. The arcuate tube 23 creates a continuous connection between the straight tube 22 and the base plate 3, which helps transfers the load on the proximal portion 25 directly to the base plate 3. As such, the exterior face 32 of the base plate 3 is terminally connected to the arcuate tube 23, opposite the straight tube 22. Preferably, the arcuate tube 23 is robustly connected to the exterior face 32 to withstand the load applied to the handle 1. For example, the arcuate tube 23 may be welded to the base plate 3, or the arcuate tube 23 and the base plate 3 may be fashioned out of a single piece of metal.

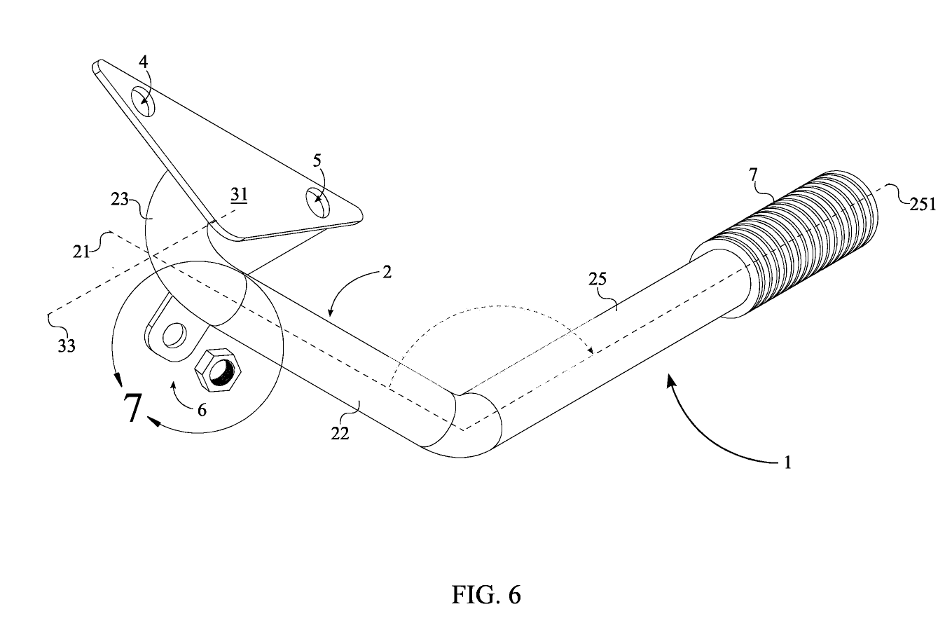

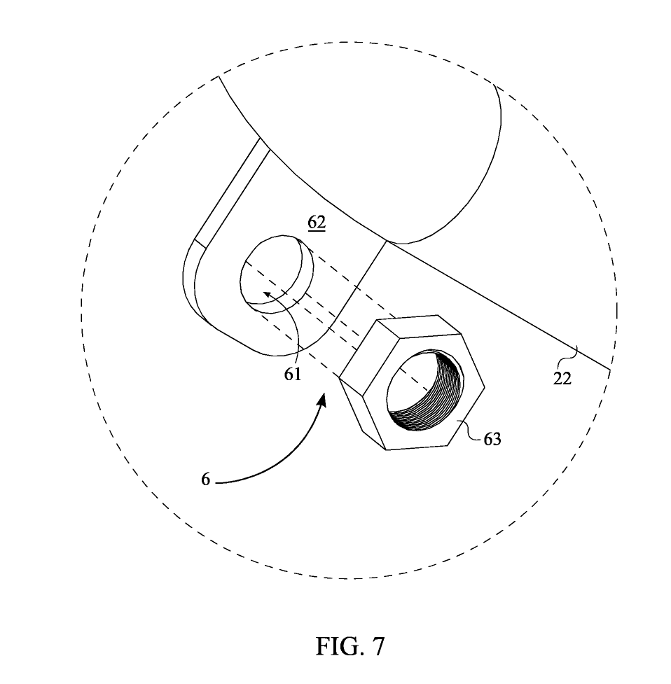

Referring to FIG. 6 and FIG. 7, in one possible embodiment of the present invention, the arm attachment mount 6 comprises a thru-hole 61, a tab 62, and a threaded nut 63. Preferably, the thru-hole 61 traverses through the tab 62. Subsequently, the thru-hole 61 allows the bolt to traverse through the tab 62 and connect to the threaded nut 63. As such, the threaded nut 63 is laterally connected to the tab 62. More specifically, the threaded nut 63 is connected opposite a bolt head of the bolt about the tab 62. The bolt preferably mounts into a hole in the mirror arm, with the bolt head pressing on one side of the hole and the tab 62 pressing on the opposite side of the hole. This creates an interlocking engagement between the mirror arm and the tab 62.

To allow the bolt to easily screw into the threaded nut 63, the threaded nut 63 is concentrically aligned to the thru-hole 61. This prevents the bolt from rubbing against the rim of the thru-hole 61 while being screwed into the threaded nut 63. In the preferred embodiment, the mirror arm must be clearly visible to the occupant. Thus, the tab 62 may be connected to either the straight tube 22 or the arcuate tube 23 if the mirror arm remains in the occupant's line of sight. This allows the occupant to have a clear view of the mirror arm while keeping the handle 1 out of the occupant's line of sight.

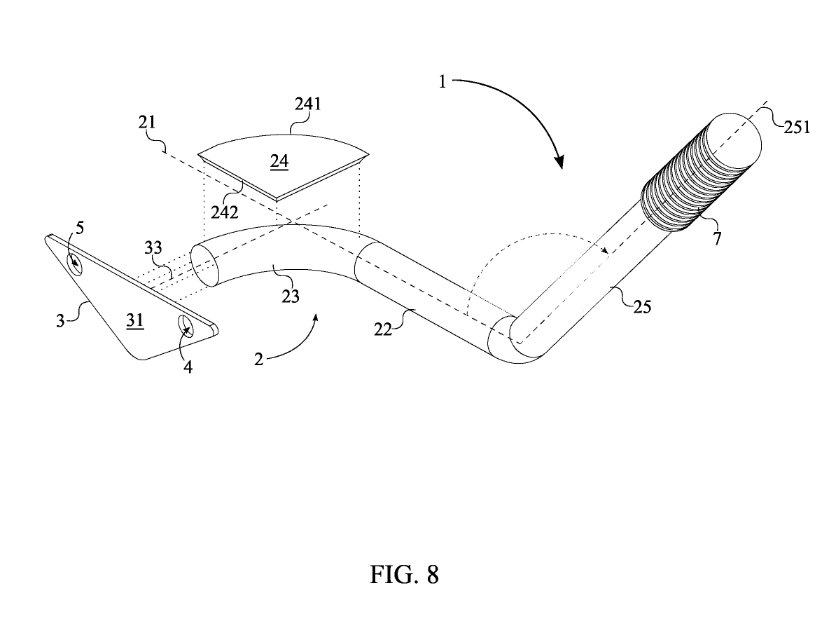

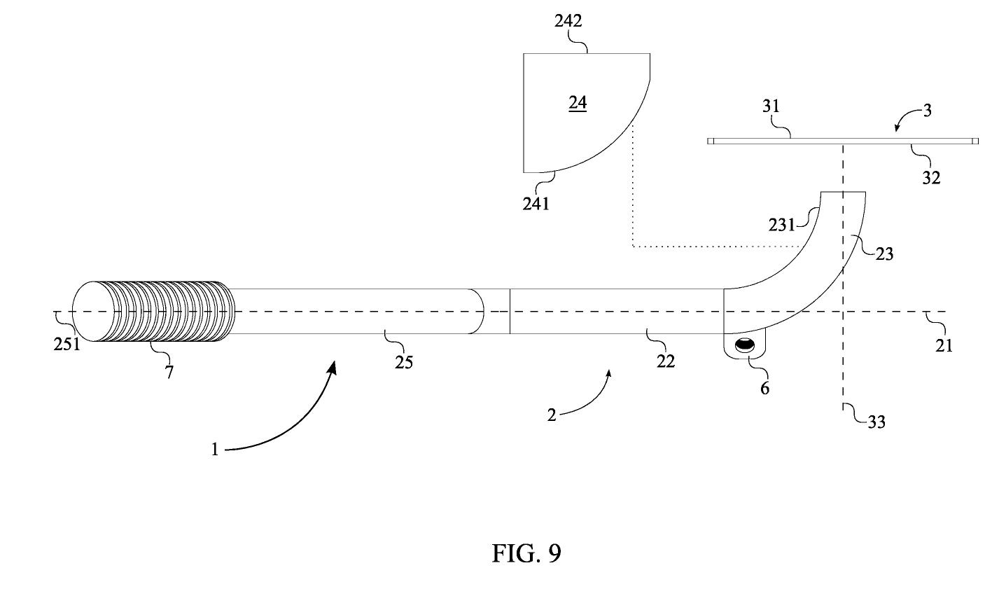

Referring to FIG. 8 and FIG. 9, in the preferred embodiment of the present invention, a structural reinforcement plate 24 is provided. The structural reinforcement plate 24 reinforces the connection between the arcuate tube 23 and the exterior face 32 of the base plate 3. Preferably, the structural reinforcement plate 24 is a flat sheet of steel that fits between the arcuate tube 23 and the base plate 3. As such, the structural reinforcement plate 24 comprises a convex side 241 and a straight side 242. Accordingly, the convex side 241 is connected onto a concave side 231 of the arcuate tube 23. Similarly, the straight side 242 is connected onto the exterior face 32 of the base plate 3. In the preferred implementation, the convex side 241 and the straight side 242 may be permanently welded, riveted, or bolted onto the concave side 231 and exterior face 32 respectively.

In another embodiment of the present invention, a grip 7 allows the occupant to securely hold onto the handle 1. The grip 7 may be a rubber tube with grooves or protrusions that act as finger holds. Preferably, the grip 7 is terminally connected around the proximal portion 25. More specifically, the proximal portion 25 may be glued or mechanically fastened into a recess of the grip 7. Alternately, the grip 7 may comprise slots, holes, and/or gaps and may be magnetically fastened to the proximal portion 25.

Although the invention has been explained in relation to its preferred embodiment, it is to be understood that many other possible modifications and variations can be made without departing from the spirit and scope of the invention as hereinafter claimed.

What is claimed is:

1. An occupant-assist mobility handle comprises:
a handle;
a base plate;
a first mounting slot;
a second mounting slot;
an arm attachment mount;
the base plate comprises a contact face and an exterior face;
the handle comprises a distal portion and a proximal portion;
the proximal portion being terminally connected to the distal portion;
the distal portion being adjacently connected to the exterior face of the base plate;
the first mounting slot traversing through the base plate from the exterior face to the contact face;
the second mounting slot traversing through the base plate from the exterior face to the contact face;
the first mounting slot and the second mounting slot being positioned opposite each other about the distal portion;
the arm attachment mount being connected adjacent to the distal portion; and
the arm attachment mount being positioned offset from the base plate.

2. The occupant-assist mobility handle comprises as claimed in claim 1:
a first normal axis being oriented perpendicular to the exterior face of the base plate; and
a first longitudinal axis of the distal portion being perpendicular to the normal axis of the base plate.

3. The occupant-assist mobility handle comprises as claimed in claim 2:
a second longitudinal axis of the proximal portion being oriented coplanar to the first longitudinal axis of the distal portion; and
the second longitudinal axis of the proximal portion being oriented at an angle to the first longitudinal axis of the distal portion.

4. The occupant-assist mobility handle comprises as claimed in claim 1:
the exterior face being positioned onto the base plate; and
the contact face being positioned onto the base plate, opposite the exterior face.

5. The occupant-assist mobility handle comprises as claimed in claim 1 comprises:
the distal portion comprises a straight tube and an arcuate tube;
the proximal portion being terminally connected to the straight tube;
the arcuate tube being terminally connected to the straight tube, opposite the proximal portion; and
the exterior face of the base plate being terminally connected to the arcuate tube, opposite the straight tube.

6. The occupant-assist mobility handle comprises as claimed in claim 1 comprises:
the distal portion further comprises a straight tube, an arcuate tube, and a structural reinforcement plate;
the structural reinforcement plate comprises a convex side and a straight side;
the convex side being connected onto a concave side of the arcuate tube; and
the straight side being connected onto the exterior face of the base plate.

7. The occupant-assist mobility handle comprises as claimed in claim 1:
a grip; and
the grip being terminally connected around the proximal portion.

8. The occupant-assist mobility handle comprises as claimed in claim 1, wherein the base plate is triangular.

9. The occupant-assist mobility handle comprises as claimed in claim 1 comprises:
the arm attachment mount comprises a thru-hole, a tab, and a threaded nut;
the thru-hole traversing through the tab;
the threaded nut being laterally connected to the tab; and
the threaded nut being concentrically aligned to the thru-hole.

10. An occupant-assist mobility handle comprises:
a handle;
a base plate;
a first mounting slot;
a second mounting slot;
an arm attachment mount;
the base plate comprises a contact face and an exterior face;
the handle comprises a distal portion and a proximal portion;
the proximal portion being terminally connected to the distal portion;
the distal portion being adjacently connected to the exterior face of the base plate;
the first mounting slot traversing through the base plate from the exterior face to the contact face;
the second mounting slot traversing through the base plate from the exterior face to the contact face;
the first mounting slot and the second mounting slot being positioned opposite each other about the distal portion;
the arm attachment mount being connected adjacent to the distal portion;
the arm attachment mount being positioned offset from the base plate;
a first normal axis being oriented perpendicular to the exterior face of the base plate;
a first longitudinal axis of the distal portion being perpendicular to the normal axis of the base plate;
a second longitudinal axis of the proximal portion being oriented coplanar to the first longitudinal axis of the distal portion; and
the second longitudinal axis of the proximal portion being oriented at an angle to the first longitudinal axis of the distal portion.

11. The occupant-assist mobility handle comprises as claimed in claim 10:
the exterior face being positioned onto the base plate; and
the contact face being positioned onto the base plate, opposite the exterior face.

12. The occupant-assist mobility handle comprises as claimed in claim 10 comprises:
the distal portion comprises a straight tube and an arcuate tube;
the proximal portion being terminally connected to the straight tube;
the arcuate tube being terminally connected to the straight tube, opposite the proximal portion; and
the exterior face of the base plate being terminally connected to the arcuate tube, opposite the straight tube.

13. The occupant-assist mobility handle comprises as claimed in claim 10 comprises:
the distal portion further comprises a straight tube, an arcuate tube, and a structural reinforcement plate;
the structural reinforcement plate comprises a convex side and a straight side;
the convex side being connected onto a concave side of the arcuate tube; and
the straight side being connected onto the exterior face of the base plate.

14. The occupant-assist mobility handle comprises as claimed in claim 10:
a grip; and
the grip being terminally connected around the proximal portion.

15. The occupant-assist mobility handle comprises as claimed in claim 10, wherein the base plate is triangular.

16. The occupant-assist mobility handle comprises as claimed in claim 10 comprises:
the arm attachment mount comprises a thru-hole, a tab, and a threaded nut;
the thru-hole traversing through the tab;
the threaded nut being laterally connected to the tab; and
the threaded nut being concentrically aligned to the thru-hole.
